(19) United States
(12) Patent Application Publication
(10) Pub. No.: US 2025/0309423 A1
(43) Pub. Date: Oct. 2, 2025

(54) ELECTROCHEMICAL DEVICE AND ELECTRONIC DEVICE

(71) Applicant: Ningde Amperex Technology Limited, Ningde (CN)

(72) Inventors: Le WANG, Ningde (CN); Xingfang ZHENG, Ningde (CN); Qiong QU, Ningde (CN); Qianwen DENG, Ningde (CN)

(73) Assignee: Ningde Amperex Technology Limited, Ningde (CN)

(21) Appl. No.: 19/089,060

(22) Filed: Mar. 25, 2025

(30) Foreign Application Priority Data
Mar. 26, 2024 (CN) 202410353478.6

(51) Int. Cl. H01M 50/184; H01M 50/105

(52) U.S. Cl. CPC H01M 50/184; H01M 50/105

(57) ABSTRACT

An electrochemical device includes a battery cell, a packaging bag, a first adhesive component, and a second adhesive component. The battery cell includes a curved lateral edge. The packaging bag includes a main portion and a seal edge portion. The battery cell is disposed in the main portion. The main portion includes a first curved surface. The seal edge portion includes a first end and a second end disposed opposite to each other. The first end is connected to the main portion. The second end is disposed on an outer side of the first curved surface. The first adhesive component is disposed between the seal edge portion and a lateral edge of the main portion. The second adhesive component is disposed at the second end. The second adhesive component covers the second end, and is bonded to an outer side of the first curved surface.

### CROSS-REFERENCE TO RELATED APPLICATION

This application claims priority to Chinese patent application 202410353478.6, filed on Mar. 26, 2024, the contents of which are incorporated herein by reference in its entirety.

### TECHNICAL FIELD

This application relates to the technical field of battery packaging, and in particular, to an electrochemical device and an electronic device.

### BACKGROUND

Pouch secondary batteries are widely used in the fields of consumer electronics as well as power and energy storage batteries by virtue of a high energy density and good safety performance. During manufacturing of the pouch secondary batteries, the lateral edge of a packaging shell needs to be cut and packaged to wrap an internal cell structure to prevent the battery cell from corroding or short-circuiting with an external circuit. However, the packaging structure of the packaging shell in the prior art is prone to increase the overall size of the battery and result in a decrease in the energy density of the battery.

How to reduce the impact of the packaging structure on the overall size of the battery has become a technical problem to be solved.

### SUMMARY

This application provides an electrochemical device and an electronic device to solve the above technical problems.

Some embodiments of this application are implemented in the following way:

An electrochemical device includes a battery cell, a packaging bag, a first adhesive component, and a second adhesive component. The battery cell includes a curved lateral edge. The packaging bag includes a main portion and a seal edge portion. The battery cell is disposed in the main portion. The main portion includes a first curved surface. The seal edge portion includes a first end and a second end disposed opposite to each other. The first end is connected to the main portion. The second end is disposed on an outer side of the first curved surface. The first adhesive component is disposed between the seal edge portion and a lateral edge of the main portion. The second adhesive component is disposed at the second end. The second adhesive component covers the second end, and is bonded to the outer side of the first curved surface. The lateral edge of the main portion may include a part of the first curved surface, or may be connected to the first curved surface.

In this way, the main part of the seal edge portion of a single-layer structure can be directly bonded to the lateral edge of the main portion through the first adhesive component, thereby reducing the dimension accumulation caused by the folding of the seal edge portion. Further, the end of the seal edge portion is covered by the second adhesive component, and the second adhesive component is disposed on the outer side of the first curved surface of the main portion, so that the second adhesive component is located in a fillet region on the outer side of the packaging bag. This arrangement avoids dimension accumulation in the thickness or width direction of the electrochemical device caused by the protrusion of the second adhesive component, substantially reduces the impact of the seal edge portion and the adhesive component on the overall size of the electrochemical device, and increases the energy density of the electrochemical device.

In a possible implementation, the first adhesive component partially overlaps the second adhesive component, thereby improving the reliability of bonding between the second adhesive component and the first curved surface and alleviating the problem of warping at the end of the seal edge portion.

In a possible implementation, along a thickness direction of the battery cell, an overlap region between the first adhesive component and the second adhesive component is 0.05 mm to 0.6 mm in dimension. This arrangement can improve the adhesion between the seal edge portion and the main portion, and reduce the loss of the energy density.

In a possible implementation, the second adhesive component is spaced apart from the first adhesive component, thereby reducing the consumption of the material of the adhesive component and reducing the overall weight of the electrochemical device.

In a possible implementation, along a thickness direction of the battery cell, a height of the main portion is H, a distance between a bottom surface of the second adhesive component and a bottom surface of the main portion is L, satisfying: 0.5H≤L<H, and a top surface of the second adhesive component does not exceed a top surface of the main portion. In this way, the second adhesive component can be constrained in the fillet region on the outer side of the first curved surface, and the packaging size of the seal edge portion can be sufficient, thereby reducing the risk of leakage of the electrochemical device.

In a possible implementation, along a thickness direction of the battery cell, a height D of the second adhesive component is 0.3 mm to 1.2 mm. This implementation can prevent metal leakage of the packaging bag, and makes the second adhesive component bonded to the seal edge portion and the main portion.

In a possible implementation, viewed from a thickness direction of the battery cell, a projection of the second adhesive component lies within a projection of the packaging bag.

In a possible implementation, in a direction extending from the first end to the second end, the dimension of the second adhesive component in the width direction of the battery cell increases gradually, so that the thicker region of the second adhesive component is close to the main portion, thereby reducing the impact on the width dimension caused by the protrusion of the second adhesive component.

In a possible implementation, along a thickness direction of the battery cell, a height from a junction between the seal edge portion and the lateral edge of the main portion to a bottom surface of the main portion is m, satisfying: m<0.1 mm.

In a possible implementation, a maximum-width position of the first adhesive component does not overlap a maximum-width position of the battery cell.

An embodiment of this application further provides an electronic device. The electronic device includes an electrical component and the electrochemical device disclosed in the above embodiment. The electrical component is electrically connected to the electrochemical device.

### BRIEF DESCRIPTION

To describe technical solutions in embodiments of this application more clearly, the following outlines the drawings to be used in the embodiments. Understandably, the following drawings show merely some embodiments of this application, and therefore, are not intended to limit the scope. A person of ordinary skill in the art may derive other related drawings from the drawings without making any creative efforts.

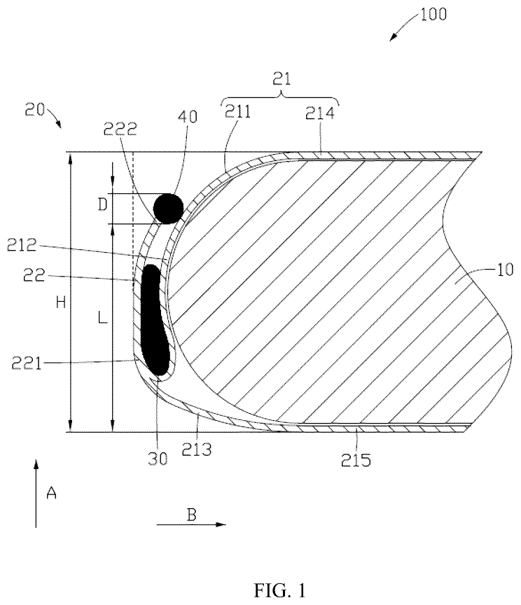

FIG. 1 is a schematic structural diagram of an electrochemical device according to an embodiment of this application;

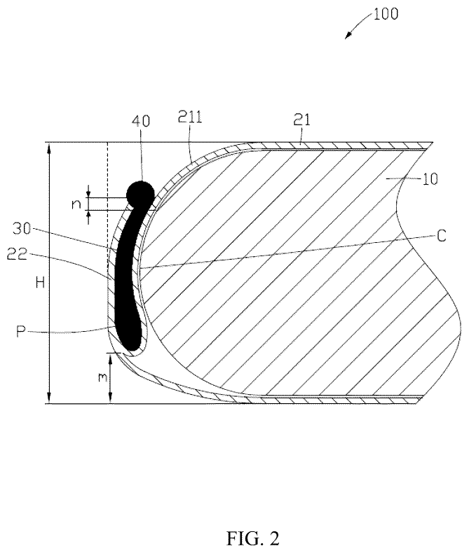

FIG. 2 is a schematic structural diagram of an electrochemical device according to an embodiment;

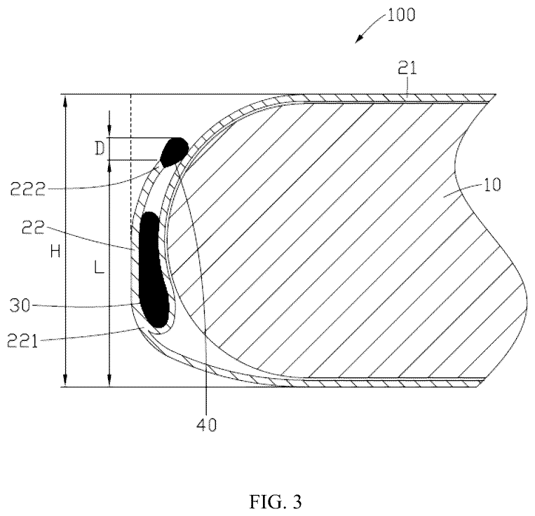

FIG. 3 is a schematic structural diagram of an electrochemical device according to an embodiment; and

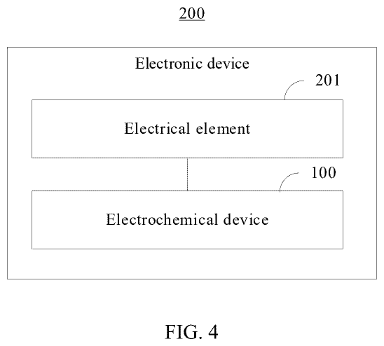

FIG. 4 is a schematic structural diagram of an electronic device according to an embodiment.

### LIST OF REFERENCE NUMERALS

electrochemical device 100
battery cell 10
packaging bag 20
main portion 21
first curved surface 211
lateral edge 212
connecting surface 213
upper surface 214
lower surface 215
seal edge portion 22
first end 221
second end 222
first adhesive component 30
second adhesive component 40
electronic device 200
electrical component 201

### DETAILED DESCRIPTION

The following clearly and thoroughly describes the technical solutions in some embodiments of this application with reference to the drawings hereto. Evidently, the described embodiments are merely a part of but not all of the embodiments of this application.

It is hereby noted that a component referred to as being “fixed to” another component may be directly fixed onto the other component or may be fixed onto the other component through an intermediate component. A component considered to be “connected to” another component may be directly connected to the other component or may be connected to the other component through an intermediate component. A component considered to be “disposed on” another component may be directly disposed on the other component or may be disposed on the other component through an intermediate component. The terms “vertical”, “horizontal”, “left”, “right” and similar expressions used herein are merely for case of description.

Unless otherwise defined, all technical and scientific terms used herein bear the same meanings as what is normally understood by a person skilled in the technical field of this application. The terms used in the specification of this application are merely intended to describe specific embodiments but not to limit this application. The term “and/or” used herein is intended to include any and all combinations of one or more relevant items recited.

The following describes some embodiments of this application in detail. To the extent that no conflict occurs, the following embodiments and the features in the embodiments may be combined with each other.

Referring to FIG. 1, this embodiment provides an electrochemical device 100, including a battery cell 10, a packaging bag 20, a first adhesive component 30, and a second adhesive component 40. The battery cell 10 includes a curved lateral edge. The packaging bag 20 covers the outer surface of the battery cell 10. The packaging bag 20 includes a main portion 21 and a seal edge portion 22. The battery cell 10 is disposed in the main portion 21. The main portion 21 includes a first curved surface 211. The seal edge portion 22 includes a first end 221 and a second end 222 disposed opposite to each other. The first end 221 is connected to the main portion 21. The second end 222 is disposed on the outer side of the first curved surface 211. The first adhesive component 30 is disposed between the seal edge portion 22 and a lateral edge of the main portion 21. The second adhesive component 40 is disposed at the second end 222 of the seal edge portion 22. The second adhesive component 40 covers the second end 222, and is bonded to the outer side of the first curved surface 211.

In an embodiment of this application, the battery cell 10 may be a jelly-roll cell or a stacked-type cell. The main portion 21 wraps the battery cell 10. The shape of the main portion 21 is substantially the same as the shape of the battery cell 10. The seal edge portion 22 may be formed by cutting the lateral edge of the packaging bag 20 after the packaging bag 20 wraps the battery cell 10. The seal edge portion 22 is bent toward the lateral edge 212 of the main portion 21, and is disposed on the lateral edge 212 of the main portion 21. The main portion 21 is fixed to the seal edge portion 22 by the first adhesive component 30 and the second adhesive component 40. The first adhesive component 30 may be disposed on the lateral edge 212 of the main portion 21 before the seal edge portion 22 is bent toward the main portion 21. When the seal edge portion 22 is bent on the lateral edge 212 of the main portion 21, the seal edge portion may directly contact and be adhesively fixed to the first adhesive component 30. The second adhesive component 40 may cover the second end 222 before the seal edge portion 22 is bent toward the main portion 21. When the seal edge portion 22 is bent on the lateral edge 212 of the main portion 21, the second adhesive component 40 may directly contact and be adhesively fixed to the first curved surface 211. In some other embodiments, the first adhesive component 30 may be disposed on the same side as the seal edge portion 22, and bent synchronously with the seal edge portion 22 and disposed on the lateral edge 212 of the main portion 21.

In this way, the main part of the seal edge portion 22 can be directly bonded to the lateral edge 212 of the main portion 21 through the first adhesive component 30, thereby reducing the dimension accumulation caused by the folding of the seal edge portion 22. Further, the end of the seal edge portion 22 is covered by the second adhesive component 49, and the second adhesive component 40 is disposed on the outer side of the first curved surface 211 of the main portion 21, so that the second adhesive component 40 is located in a fillet region on the outer side of the packaging bag 20. This arrangement avoids dimension accumulation in the thickness or width direction of the electrochemical device 100 caused by the protrusion of the second adhesive component 40, substantially reduces the impact of the seal edge portion 22 and the adhesive component on the overall size of the electrochemical device 100, and increases the energy density of the electrochemical device 100. The second adhesive component 40 can also bond the seal edge portion 22 to the main portion 21 to prevent the seal edge portion 22 from warping.

In some embodiments, the first curved surface 211 is located at an upper end of the lateral edge 212 of the main portion 21. The second end 222 of the seal edge portion 22 exceeds a half of the thickness of the battery cell 10, and falls in the fillet region on the outer side of the first curved surface 211. The direction indicated by arrow A shown in FIG. 1 is the thickness direction of the battery cell 10, and the direction indicated by arrow B is the width direction of the battery cell 10. Along the thickness direction of the battery cell 10, the height of the main portion 21 is H, and is a vertical distance between an upper surface 214 and a lower surface 215 of the main portion 21. The distance between a bottom surface of the second adhesive component 40 and a bottom surface of the main portion is L, satisfying: 0.5H≤L<H, and a top surface of the second adhesive component 40 does not exceed a top surface of the main portion 21. In this way, the second adhesive component 40 can be constrained in the fillet region on the outer side of the first curved surface 21, and the packaging size of the seal edge portion 22 can be sufficient, thereby reducing the risk of leakage of the electrochemical device.

In some implementations, along the thickness direction of the battery cell 10, the height D of the second adhesive component 40 is 0.3 mm to 1.2 mm, thereby meeting the requirement on the bonding strength while minimizing the amount of size by which the second adhesive component 40 protrudes from the first curved surface 211. The material of the second adhesive component 40 may be a hot-melt adhesive or an ultraviolet curable adhesive (UV adhesive). By limiting the size of the second adhesive component 40, this application can control the curing time of the second adhesive component 40 within a reasonable range, thereby optimizing the manufacturing process of the electrochemical device 100.

In some embodiments, along the thickness direction of the battery cell 10, the bottom of the first adhesive component 30 fills the space between the main portion 21 and the seal edge portion 22, and the upper end of the first adhesive component 30 exceeds a half-thickness position of the battery cell 10, so that the first adhesive component 30 provides a sufficient bonding length to improve the reliability of bonding between the seal edge portion 22 and the main portion 21. As shown in FIG. 2, in some embodiments, the material of the first adhesive component 30 may be a hot-melt adhesive or an ultraviolet curable adhesive. During the bonding or curing, the upper thickness is not equal to the lower thickness of the first adhesive component 30. A maximum-width position P of the first adhesive component 30 does not overlap a maximum-width position C of the battery cell 10, thereby reducing the impact of the first adhesive component 30 on the width dimension.

In a possible implementation, the second adhesive component 40 is spaced apart from the first adhesive component 30, and the first adhesive component 30 does not completely fill the space between the seal edge portion 22 and the main portion 21, thereby reducing the consumption of the material of the adhesive component and reducing the overall weight of the electrochemical device.

In some embodiments, a connecting surface 213 is provided between the lower surface 215 of the main portion 21 and the seal edge portion 22. The connecting surface 213 may be a curved surface structure. The space between the battery cell 10 and the connecting surface 213 may be an air bag or filled with an electrolyte solution. During the drop of the electrochemical device, the connecting surface 213 that assumes the curved surface structure can reduce stress concentration, and the space between the battery cell 10 and the connecting surface 213 can serve as a buffer space to absorb external impact force and alleviate the damage caused by the drop.

Referring to FIG. 2, in some embodiments, the first adhesive component 30 and the second adhesive component 40 partially overlap. Specifically, the first adhesive component 30 may be disposed on the lateral edge 212 of the main portion 21 before the seal edge portion 22 is bent toward the main portion 21, and the second adhesive component 40 may cover the second end 222 before the seal edge portion 22 is bent toward the main portion 21. When the seal edge portion 22 is bent on the lateral edge 212 of the main portion 21, the second adhesive component 40 may partially overlap the first adhesive component 30 and be adhesively fixed to the first curved surface 211. The first adhesive component 30 fills the space between the seal edge portion 22 and the main portion 21, thereby maximizing the bonding region of the first adhesive component 30. The overlap region between the first adhesive component 30 and the second adhesive component 40 can also connect the two adhesive components into one, thereby improving the reliability of bonding between the second adhesive component 40 and the first curved surface 211 and alleviating the problem of warping at the end of the seal edge portion.

In some implementations, along the thickness direction of the battery cell 10, the overlap region between the first adhesive component 30 and the second adhesive component 40 is 0.05 mm to 0.6 mm in dimension n, thereby allowing the second adhesive component 40 to not only partially overlap the first adhesive component 30 but also be bonded to the first curved surface 211. This implementation not only meets the requirement of bonding between the first adhesive component 30 and the second adhesive component 40, but also prevents the bonding region between the second adhesive component 40 and the first curved surface 211 from being excessively small. This overlap region can also improve the adhesion between the seal edge portion 22 and the main portion 21, and reduce the loss of the energy density.

In some implementations, viewed from the thickness direction of the battery cell 10, the projection of the second adhesive component 40 lies within the projection of the packaging bag 20. In this way, the outermost side of the second adhesive component 40 is prevented from exceeding the outermost side of the seal edge portion 22. The outermost side of the seal edge portion 22 can be used as a starting point for measuring the width of the packaging bag 20. The disposed second adhesive component 40 is prevented from causing dimension accumulation in the width direction of the electrochemical device 100, thereby increasing the energy density.

Referring back to FIG. 2, in some implementations, along the thickness direction of the battery cell 10, a height from a junction between the seal edge portion 22 and the lateral edge of the main portion 21 to a bottom surface of the main portion 21 is m, satisfying: m<0.1 mm. In this way, the height of the entire seal edge portion 22 can be reduced, and the seal edge portion 22 can be closer to the bottom surface of the main portion 21, thereby making the seal edge portion more favorably applicable in a solution in which the edge of a thin battery cell is folded.

Referring to FIG. 3, in some implementations, in a direction extending from the first end 221 to the second end 22, or in a direction extending toward the upper surface 214 of the main portion 21 along the first curved surface 211, the dimension of the second adhesive component 40 in the width direction of the battery cell 10 increases gradually. The second adhesive component 40 is roughly teardrop-shaped or elliptical. In this way, the thicker region of the second adhesive component 40 can be close to the first curved surface 211 of the main portion 21, and a larger part of the second adhesive component 40 can be accommodated in the fillet region on the outer side of the first curved surface 211, thereby reducing the impact caused by the outward protrusion of the second adhesive component 40 to the width dimension. The teardrop-shaped or elliptical second adhesive component 40 is also conducive to increasing the area of bonding to the first curved surface 211 and improving the connection reliability.

In a specific implementation, compared with a double-fold packaging structure, that is, a two-layer structure formed by folding the seal edge portion 22 on the lateral edge of the main portion 21, the width of the electrochemical device in this application is reduced by an amount equal to 0.4 mm×2=0.8 mm. Using a battery in a mobile phone as an example, if the width of the electrochemical device is 50 mm, the energy density gain brought by the reduction in the width of the electrochemical device in this application is 1.6%. Using a battery in a wearable device as an example, if the width of the battery cell is 25 mm, the energy density gain brought by the reduction in the width of the electrochemical device in this application is 3.2%.

Referring to FIG. 4, an embodiment of this application further provides an electronic device 200. The electronic device includes an electrical component 201 and the electrochemical device 100 disclosed in the above embodiment. The electrical component 201 is electrically connected to the electrochemical device 100 so that electrical energy is provided to the electrical component 201.

The foregoing embodiments are merely intended for describing the technical solutions of this application but not intended as a limitation. Although this application is described in detail with reference to the foregoing exemplary embodiments, a person of ordinary skill in the art understands that modifications or equivalent substitutions may be made to the technical solutions of this application without departing from the spirit and scope of the technical solutions of this application.

What is claimed is:

1. An electrochemical device, comprising:
a battery cell, wherein the battery cell comprises a curved lateral edge;
a packaging bag, wherein the packaging bag comprises a main portion and a seal edge portion, the battery cell is disposed in the main portion, the main portion comprises a first curved surface, the seal edge portion comprises a first end and a second end disposed opposite to each other, the first end is connected to the main portion, and the second end is disposed on an outer side of the first curved surface;
a first adhesive component, disposed between the seal edge portion and a lateral edge of the main portion; and
a second adhesive component disposed at the second end, wherein the second adhesive component covers the second end, and is bonded to an outer side of the first curved surface.

2. The electrochemical device according to claim 1, wherein
the first adhesive component partially overlaps the second adhesive component.

3. The electrochemical device according to claim 2, wherein
along a thickness direction of the battery cell, an overlap region between the first adhesive component and the second adhesive component is 0.05 mm to 0.6 mm in dimension.

4. The electrochemical device according to claim 1, wherein
the second adhesive component is spaced apart from the first adhesive component.

5. The electrochemical device according to claim 1, wherein
along a thickness direction of the battery cell, a height of the electrochemical device at the main portion is H, a distance between a bottom surface of the second adhesive component and a bottom surface of the main portion is L, wherein 0.5H≤L<H, and a top surface of the second adhesive component does not exceed a top surface of the main portion.

6. The electrochemical device according to claim 1, wherein
along a thickness direction of the battery cell, a height D of the second adhesive component is 0.3 mm to 1.2 mm.

7. The electrochemical device according to claim 2, wherein
along a thickness direction of the battery cell, a height D of the second adhesive component is 0.3 mm to 1.2 mm.

8. The electrochemical device according to claim 1, wherein
viewed from a thickness direction of the battery cell, a projection of the second adhesive component lies within a projection of the packaging bag.

9. The electrochemical device according to claim 2, wherein
viewed from a thickness direction of the battery cell, a projection of the second adhesive component lies within a projection of the packaging bag.

10. The electrochemical device according to claim 1, wherein
in a direction extending from the first end to the second end, a dimension of the second adhesive component in a width direction of the battery cell increases gradually.

11. The electrochemical device according to claim 1, wherein
along a thickness direction of the battery cell, a height from a junction between the seal edge portion and the lateral edge of the main portion to a bottom surface of the main portion is m, and m<0.1 mm.

12. The electrochemical device according to claim 5, wherein
along a thickness direction of the battery cell, a height from a junction between the seal edge portion and the lateral edge of the main portion to a bottom surface of the main portion is m, and m<0.1 mm.

13. The electrochemical device according to claim 1, wherein
a maximum-width position of the first adhesive component does not overlap a maximum-width position of the battery cell.

14. An electronic device, wherein the electronic device comprises an electrical component and the electrochemical device according to claim 1, and the electrical component is electrically connected to the electrochemical device.

15. The electronic device according to claim 14, wherein
the first adhesive component partially overlaps the second adhesive component.

16. The electronic device according to claim 14, wherein
along a thickness direction of the battery cell, an overlap region between the first adhesive component and the second adhesive component is 0.05 mm to 0.6 mm in dimension.

17. The electronic device according to claim 14, the second adhesive component is spaced apart from the first adhesive component.

18. The electronic device according to claim 14, wherein
along a thickness direction of the battery cell, a height of the electrochemical device at the main portion is H, a distance between a bottom surface of the second adhesive component and a bottom surface of the main portion is L, wherein: 0.5H≤L<H, and a top surface of the second adhesive component does not exceed a top surface of the main portion.

19. The electronic device according to claim 14, wherein
along a thickness direction of the battery cell, a height D of the second adhesive component is 0.3 mm to 1.2 mm.

20. The electronic device according to claim 14, wherein
viewed from a thickness direction of the battery cell, a projection of the second adhesive component lies within a projection of the packaging bag.
